(19) United States
(12) Patent Application Publication
(10) Pub. No.: US 2024/0249421 A1
(43) Pub. Date: Jul. 25, 2024

(54) GENERATION SYSTEM AND GENERATION METHOD FOR METADATA FOR MOVEMENT ESTIMATION

(71) Applicant: IPIXEL CO., LTD., Seoul (KR)

(72) Inventors: Barend Thomas HARRIS, Seoul (KR); Hyeon Woo Jeong, Gyeonggi-do (KR); Seung Min Yoon, Seoul (KR)

(73) Assignee: IPIXEL CO., LTD., Seoul (KR)

(21) Appl. No.: 18/626,533

(22) Filed: Apr. 4, 2024

Related U.S. Application Data
(63) Continuation of application No. PCT/KR2021/014928, filed on Oct. 22, 2021.

(30) Foreign Application Priority Data
Oct. 5, 2021 (KR) 10-2021-0131896

(51) Int. Cl. G06T 7/246; G06T 7/62; G06T 7/73

(52) U.S. Cl. CPC G06T 7/246; G06T 7/62; G06T 7/73

(57) ABSTRACT

A generation method for metadata for movement estimation includes separating, from video, a movement occurrence portion in units of scenes in which a scene changes, extracting pose information from the separated video data, and generating metadata from the pose information.

### CROSS-REFERENCE TO RELATED APPLICATION(S) AND PRIORITY

The present application is a continuation of, and claims priority to, PCT Patent Application No. PCT/KR2021/014928 filed Oct. 22, 2021, which claims priority to Korean Patent Application No. 10-2021-0131896 filed on Oct. 5, 2021, the disclosures of which are hereby incorporated herein by reference in their entirety.

### FIELD OF THE DISCLOSURE

The present disclosure relates to a system and method for generating metadata for movement estimation.

### BACKGROUND

With more indoor activity due to COVID-19, video content is on the rise. As a result, much research is underway to understand, summarize, and analyze large amounts of video content. To efficiently analyze such countless pieces of video content, deep learning technologies are attracting attention these days. To effectively and successfully apply deep learning technologies, it is necessary to generate and use various types of massive quality metadata.

As conventional art related thereto, Korean Patent Application Publication No. 2015-0079064, entitled “Automatic tagging system” discloses a technique for only extracting visual and physical information and semantic information of still images, and Korean Patent Application Publication No. 2011-0020158, entitled “Metadata tagging system, image searching method, device, and method for tagging gesture” discloses a technique for analyzing an image and extracting temporal information and place information. However, the conventional art is limited to tagging of visual information in images and may not ensure quality metadata. Also, it is not possible to generate integrated metadata including all of visual information, sound information, subtitle information, and caption information, and tagging a large amount of data involves a high cost and also is difficult to do.

In particular, as indoor activities increase, video-based non-face-to-face online coaching services, such as online classes and home training, are coming into the limelight. However, most of video-based online coaching services are implemented not in a bidirectional coaching manner in which feedback is obtainable but in a unidirectional teaching manner in which knowledge is delivered in a single direction. Accordingly, a user is required to determine by himself or herself how well he or she is doing or how good a result is. Particularly, in the case of a home training service employing a video, when the content is provided in a unidirectional coaching manner, there is a risk of injury because users are likely to perform actions in a wrong way.

To solve the foregoing problem, there is a need for a system for analyzing a user's video, recording movement, and providing feedback. For example, the system may extract frames with movement in a video, acquire information on the movement, and provide information on the movement, such as the number of repetitions and similarity, statistics on each user's movement, and the like using the acquired information on the movement.

However, to generate information for feedback, it is necessary to extract a desired portion of a video and generate several pieces of metadata of movement. This metadata generation process is time-consuming and labor-intensive. Therefore, technology is required to semi-automate the process and efficiently generate metadata.

### SUMMARY

To solve the foregoing problem, the present disclosure is directed to providing a system and method for generating metadata for movement estimation.

One aspect of the present disclosure provides a method of generating metadata for movement estimation which is executable in a computing device, the method including: extracting movement occurrence portions from a video in units of scenes in which a scene changes; extracting pose information from separated video data; and generating metadata from the pose information.

The extracting of the pose information may include: extracting a movement occurrence frame on the basis of a change in video intensity; extracting key points using a deep-learning-based pose estimation model; determining whether a key pose of a movement is determinable and, when the key pose of the movement is indeterminable, determining the key pose from the extracted key points and generating a reference movement; determining whether the key pose of the movement is determinable and, when the key pose of the movement is determinable, acquiring key pose information of the movement; and determining a similarity by comparing the extracted key points with the reference movement.

The extracting of the movement occurrence frame on the basis of the change in video intensity may include: determining an intensity variation measurement region in a specific frame of the video; calculating intensity variation values of the measurement region in frame units; and extracting time information of the intensity variation values between a minimum threshold and a maximum threshold of the intensity variation values acquired to derive a movement candidate scene.

The method may further include, after the extracting of the time information of the intensity variation values, storing metadata of the movement candidate scene from a start point to an end point of a movement scene on the basis of the extracted time information.

The generating of the metadata from the pose information may include: acquiring metadata of the video; acquiring metadata of the movement; and storing pose metadata and the movement metadata in a metadata storage unit.

In the extracting of the movement occurrence portions from the video in units of the scenes in which a scene changes, a computer-vision-based deep learning algorithm may be used.

The determining of the key pose from the extracted key points and the generating of the reference movement may include: determining a similar movement which is determined to exceed the extracted key points and a preset similarity; and reading movement metadata of the similar movement.

The similarity may be determined on the basis of distance data and angle data between the extracted key points.

The method may further include, after the reading of the movement metadata of the similar movement, finely tuning metadata of the reference movement.

The fine tuning of the metadata of the reference movement may include, when a user in whom the movement occurs is determined to be a user of movement metadata of the similar movement or metadata of the user in whom the movement occurs is similar to metadata of a user of the similar movement, finely tuning the metadata of the reference movement on the basis of the metadata of the user of the similar movement.

Another aspect of the present disclosure provides a system for generating metadata including: a transceiver unit configured to externally transmit and receive data through a network; a memory unit including a video storage unit configured to store an application for controlling the system for generating metadata and store video content and a metadata storage unit configured to store pose metadata and movement metadata; and a processor configured to read the application from the memory unit and control the system. The application extracts movement occurrence portions from a video in units of scenes in which a scene changes, extracts pose information from separated video data, and generates metadata from the pose information.

A method of generating metadata for movement estimation that is executable in a computing device and a system for generating metadata for movement estimation according to the present disclosure can be implemented so that extraction of scenes with a person and scenes with movement from video data can be automatically determined by the system rather than a person. Also, these scenes are stored in the form of metadata rather than images, which allows effective provision of feedback and optimal capacity management.

With a method of generating metadata for movement estimation that is executable in a computing device and a system for generating metadata for movement estimation according to the present disclosure, an acquisition process of acquiring key points of a user, which can be modified and edited, from each scene is automated. Using the acquired key points, it is possible to finally store information on the person's movement in the form of metadata, which allows modification, editing, and efficient management.

Effects of the present disclosure are not limited to those described above, and other effects which have not been described will be clearly understood by those of ordinary skill in the art from the following description.

### BRIEF DESCRIPTION OF THE DRAWINGS

FIG. 1 is a flowchart illustrating a method of generating metadata according to the present disclosure.

FIG. 2 is a flowchart further illustrating one aspect of the method of generating metadata of FIG. 1 in detail.

FIG. 3 is a flowchart further illustrating another aspect of the method of generating metadata of FIG. 1 in detail.

FIG. 4 is a flowchart illustrating further another aspect of the method of generating metadata according to the present disclosure in detail.

FIG. 5 is a block diagram of a system for generating metadata according to the present disclosure.

FIG. 6 is a diagram illustrating a method of extracting movement occurrence frames on the basis of a change in video intensity.

FIG. 7 depicts a process for acquiring scenes with movement in a video.

FIG. 8 depicts an example of deriving key points from a scene with movement and comparing the key points with a reference pose.

### DETAILED DESCRIPTION

Hereinafter, exemplary embodiments of the present disclosure will be described in detail with reference to the accompanying drawings. Advantages and features of the present disclosure and methods of achieving the same will become clear with reference to the embodiments described in detail with the accompanying drawings. However, the technical spirit of the present disclosure is not limited to the following embodiments and may be implemented in a variety of different forms. The following embodiments are provided to make the technical spirit of the present disclosure complete and fully convey the scope of the present disclosure to those skilled in the technical field to which the present disclosure pertains. The technical spirit of the present disclosure is only defined by the scope of the claims.

In giving reference numerals to components of each drawing, it should be noted that the same reference numerals are assigned to the same components as much as possible even when the same components are shown in different drawings. In addition, in describing the present disclosure, when it is determined that the detailed description of a related well-known configuration or function obscures the subject matter of the present disclosure, the detailed description will be omitted.

Unless otherwise defined, all terms (including technical or scientific terms) used herein have meanings that are generally understood by those skilled in the technical field to which the present disclosure pertains. Terms defined in generally used dictionaries are not construed ideally or excessively unless defined apparently and specifically. Terms used in this specification are used only to describe embodiments while not limiting the present disclosure. In this specification, the singular forms include the plural forms as well unless the context clearly indicates otherwise.

In describing the components of the present disclosure, terms such as “first,” “second,” “A,” “B,” “(a),” “(b),” and the like may be used. These terms are only for distinguishing the components from other components, and an essence, a sequence, an order, or the like of the components is not limited by the terms. When a component is described as being “coupled,” “combined,” “or “connected” with another component, the components may be directly coupled or connected, but it will be understood that another component may be “coupled,” “combined,” or “connected” therebetween.

As used herein, the terms “comprise” and/or “comprising” do not preclude the presence or addition of one or more components, steps, operations, and/or elements other than stated components, steps, operations, and/or elements.

A component having the same function as a component included in any one embodiment may be described using the same name in another embodiment. Unless otherwise described, description of any one embodiment may apply to other embodiments. Detailed description may be omitted when the description is reiterated or clearly understood by those of ordinary skill in the art.

The present disclosure will be described below with reference to exemplary embodiments of the present disclosure and the accompanying drawings.

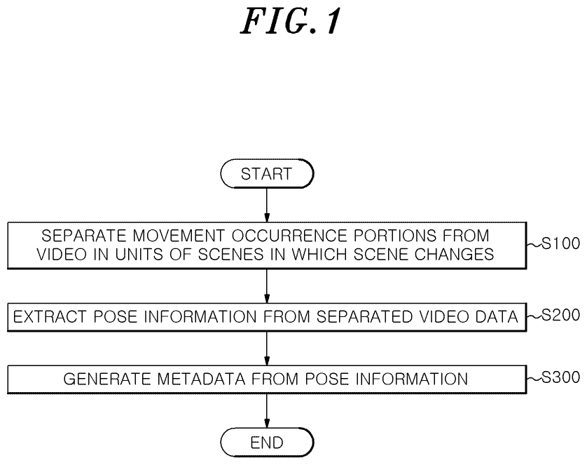

FIG. 1 is a flowchart illustrating a method of generating metadata according to the present disclosure. Referring to FIG. 1, the method of generating metadata according to the present disclosure includes an operation S100 of extracting movement occurrence portions from a video in units of scenes in which a scene changes, an operation S200 of extracting pose information from separated video data, and an operation S300 of generating metadata from the pose information.

In the method of generating metadata according to the present disclosure, it is necessary to separate and extract movements in a video to compare a movement provided in video content with a user's movement and provide feedback. Accordingly, it is necessary to analyze what types of movements exist in each unit of scene of the video.

In the operation S100 of extracting the movement occurrence portions from the video in units of scenes in which a scene changes, the video data may be interpreted in units of scenes to separate and extract the movement occurrence portions. The video data includes not only movements but also composite data such as objects, a background, and the like, and the present disclosure only requires movement data for efficient feedback. Accordingly, a process of selecting scenes including frame information of a portion of the video data with a movement intended by the user is performed in this operation S100. In this operation S100, a computer-vision-based deep learning algorithm may be used.

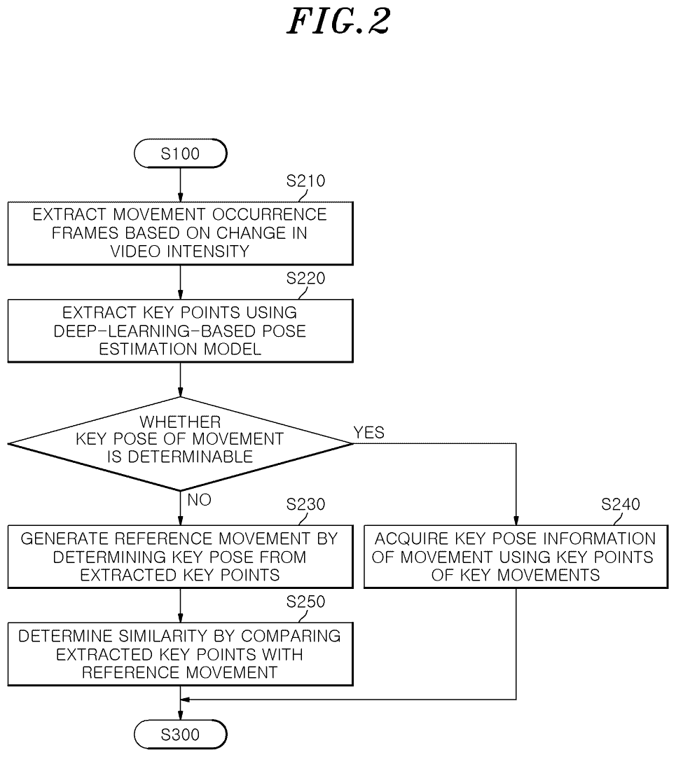

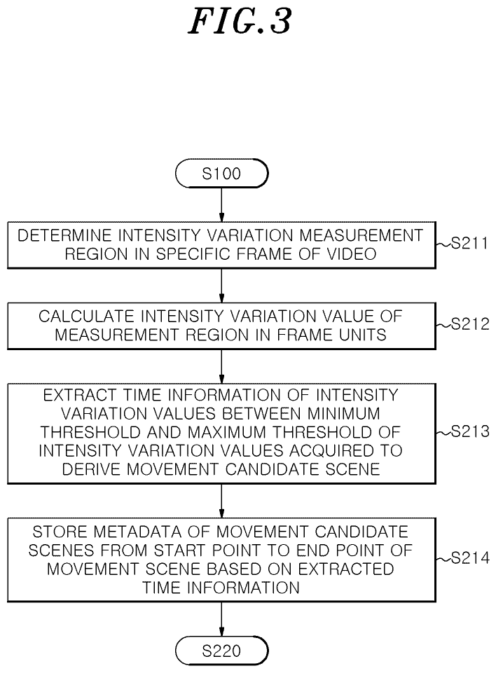

The operation S200 of extracting the pose information from the separated video data is an operation of extracting frames of a portion corresponding to a key pose of the movement from the video split into scenes to acquire and compare the pose information with a predefined movement. When no movement is defined in advance, key points may be automatically extracted using a pose estimation model based on deep learning, and metainformation of a similar movement may be loaded to automatically perform fine tuning so that metainformation of a new movement can be generated. Suboperations of this operation S200 will be described with reference to FIGS. 2 and 3. The pose estimation model employs a deep learning model and includes not only a two-dimensional (2D) model for acquiring position information but also a three-dimensional (3D) model for acquiring depth information as well.

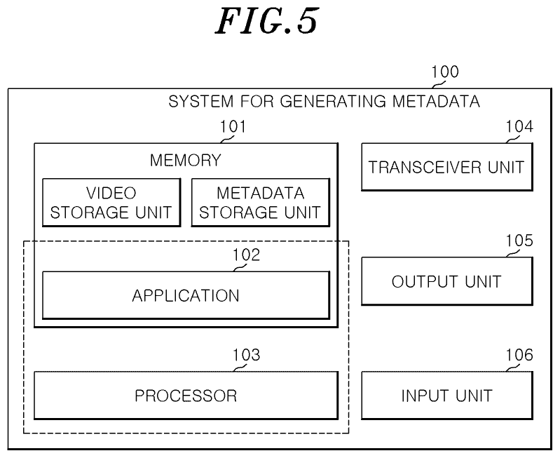

After scenes are classified by all movements and the pose information is extracted through the previous operation S200, each movement and the occurrence time thereof may be determined from video metainformation in the operation S300 of generating the metadata from the pose information. Finally obtained metadata is stored in a memory (101 of FIG. 5) managed by a system (100 of FIG. 5). Specifically, the metadata may be classified into key pose metadata and movement metadata. The movement metadata may include a start time at which the movement occurs, a time at which the movement ends, an identification (ID) of the movement, and a repetition number information of the movement. The key pose metadata may include object information, such as key point coordinate information of a key pose, a size of the person, and a ratio, and metadata of time intervals at which the movement is repeated.

FIG. 2 is a flowchart illustrating one aspect of the method of generating metadata according to the present disclosure in detail. More specifically, referring to FIG. 2, the operation S100 of extracting the pose information includes an operation S210 of extracting a movement occurrence frame on the basis of a change in video intensity, an operation S220 of extracting key points using a deep-learning-based pose estimation model, an operation S230 of determining whether a key pose of the movement is determinable and, when the key pose of the movement is indeterminable, determining the key pose from the extracted key points and generating a reference movement, an operation S240 of acquiring key pose information of the movement using key points of key movements when the key pose of the movement is determinable, and an operation S250 of determining a similarity by comparing the extracted key points with the reference movement.

In the operation S210 of extracting the movement occurrence frame on the basis of the change in video intensity, the movement occurrence frame is extracted using the characteristic that objects and backgrounds have very small intensity variation values or have very drastic variation values whereas continuous movement of the same object has an intensity variation value that gradually changes within a certain range. The method and system according to the present disclosure may employ a computer vision algorithm based on a change in video intensity to automatically search for frames in which movement is performed. The computer vision algorithm will be described in detail below with reference to FIG. 3.

In the operation S220 of extracting the key points using the deep-learning-based pose estimation model, key points are extracted from a selected scene using the deep-learning-based pose estimation model. The extracted key points are required for generating metadata of the key pose which is the reference movement. In this specification, a pose required for performing each movement is referred to as a key pose, and it is necessary to set a key pose for each movement.

In the operation S230 of determining whether the key pose of the movement is determinable and, when the key pose of the movement is indeterminable, determining the key pose from the extracted key points and generating the reference movement, when the movement is not defined in advance, metainformation of a similar movement may be loaded on the basis of the extracted key points to generate the reference movement.

The operation of generating the reference movement may include the following operations:
1) an operation of determining a similar movement which is determined to exceed the extracted key points and a preset similarity;
2) an operation of reading movement metadata of the similar movement; and
3) an operation of finely tuning metadata of the reference movement after the operation of reading the movement metadata of the similar movement.

In the operation of finely tuning metadata of the reference movement, when the user in whom the movement occurred is determined to be a user of movement metadata of the similar movement or metadata of the user in whom the movement occurred is similar to metadata of a user of the similar movement, the metadata of the reference movement is finely tuned on the basis of the metadata of the user of the similar movement.

In the operation S240 of acquiring the key pose information of the movement using the key points of the key movements when the key pose of the movement is determinable, the key pose information may be acquired on the basis of whether the extracted key points match corresponding predetermined key pose information. Key poses are generally defined in advance, and a deep learning model may be used for defining key poses in advance.

In various embodiments, each key pose may be stored as metadata. When key points of the key poses are used, it is possible to generate metadata of a value approximating to the size of a person, center coordinate information which allows comparison of the same movement and the key poses at the same position, and the importance of each key point. Also, the metadata may be generated about whether there is rotation, a rotation direction, how many seconds the key pose is held if the key pose of the movement is still (e.g., plank), and whether a deep learning model for estimating a key point works well.

In various embodiments, a method of generating the metadata obtained from key points will be described below:
1) In the case of the size of a person, generally, a portion corresponding to a torso may be extracted from key points to calculate a height, and the height may be multiplied by a constant to approximate the size. Finally, the constant and the torso or reference coordinates are stored as a metadata.
2) In the case of center coordinates, when assuming a key pose for a movement, key points that change the least may be selected and stored as metadata.
3) The importance of a key point denotes a joint that is a key to assuming an important pose. Importance is set to “0” by default, and the importance of a key point is set to a value between “0” and “1” and stored.

In various embodiments, the Metadata not obtained from key points is set as follows:
1) As rotation data, an angle is determined on the basis of a direction of a person's face. For example, the rotation data may have any one value of 0 degrees, −90 degrees, and 90 degrees.
2) Regarding whether a movement is stopped, a movement and a key pose thereof are determined, and then a time in which the movement or pose is stopped is calculated and stored as metadata.
3) Regarding whether a deep learning model works, a key point is not estimated well according to a pose in some cases, and information about whether a key point is estimated may be stored as metadata.

In the operation S250 of determining the similarity by comparing the extracted key points with the reference movement, the similarity may be determined on the basis of distance data and angle data between the extracted key points.

FIG. 3 is a flowchart illustrating further another aspect of the method of generating metadata according to the present disclosure in detail. Referring to FIG. 3, the operation S210 of extracting the movement occurrence frame on the basis of the change in video intensity includes the following operations: an operation S211 of determining an intensity variation measurement region in a specific frame of the video; an operation S212 of calculating intensity variation values of the measurement region in frame units; and an operation S213 of extracting time information of the intensity variation values between a minimum threshold and a maximum threshold of the intensity variation values acquired to derive a movement candidate scene. After the operation S213 of extracting the time information of the intensity variation values, the operation S210 may further include an operation S214 of storing metadata of the movement candidate scene from a start point to an end point of a movement scene on the basis of the extracted time information.

As described above, in the operation S210 of extracting the movement occurrence frame on the basis of the change in video intensity, the characteristic that objects and backgrounds have very small intensity variation values or have very drastic variation values whereas continuous movement of the same object has an intensity variation value that gradually changes within a certain range is used.

In the operation S211 of determining the intensity variation measurement region in the specific frame of the video, a region in which an intensity variation will be measured is defined in the video. For example, the region may be defined as all or part of the video.

In the operation S212 of calculating the intensity variation values of the measurement region in frame units, the intensity variation values are defined as values calculated by subtracting a previous frame intensity from a current frame intensity. In general, intensity differences between N previous frames and the current frame are calculated. N is generally equal to 10. To efficiently calculate an intensity variation, a queue data structure with a size of N may be used. Variation values may be calculated for all frames of the video data.

In the operation S213 of extracting the time information of the intensity variation values between the minimum threshold and the maximum threshold of the intensity variation values acquired to derive the movement candidate scene, the minimum threshold and the maximum threshold are determined from the intensity variation values acquired to classify candidate scenes with a desired movement, and time information of the intensity variation values between the minimum threshold and the maximum threshold is extracted. The earliest time of the extracted time information is determined as an initial movement start time to generate information of (movement start, movement end). For example, when values of 1, 6, 159, 253, 300, 350, and the like are obtained as time information, values of (1, 6), (159, 253), (300, 350), and the like are generated. Using this, it is possible to automatically acquire the times of scenes with movement.

In the operation S214 of storing the metadata of the movement candidate scene from the start point to the end point of the movement scene on the basis of the extracted time information, acquired scenes are stored in the form of metadata rather than the video. The stored metadata of the video includes an ID, a start time, and an end time of the movement, and in some cases, repetition number information of the movement.

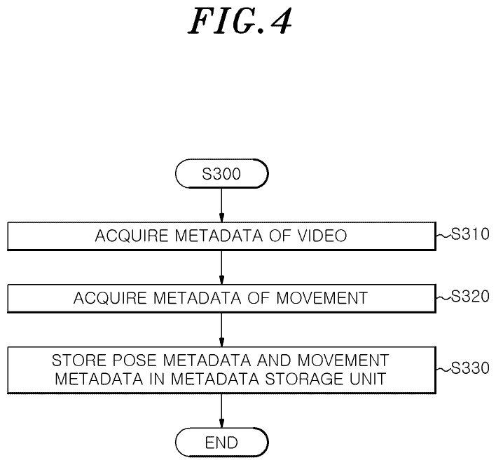

FIG. 4 is a flowchart illustrating the operation S300 of the method of generating metadata according to the present disclosure in detail. Referring to FIG. 4, the operation S300 of generating the metadata from the pose information includes an operation S310 of acquiring metadata of the video, an operation S320 of acquiring metadata of the movement, and an operation S330 of storing pose metadata and the movement metadata in a metadata storage unit.

FIG. 5 is a block diagram of a system 100 for generating metadata according to the present disclosure. The system 100 for generating metadata includes a memory 101, a processor 103, a transceiver unit 104, an output unit 105, an input unit 106, and an application 102 which is read from the memory 101 and controlled by the processor 103.

The processor 103 performs an overall control function of a terminal using a program or data stored in the memory 101 provided in the terminal. The processor 103 may include a random access memory (RAM), a read-only memory (ROM), a central processing unit (CPU), a graphics processing unit (GPU), and a bus, and the RAM, the ROM, the CPU, the GPU, and the like may be connected to each other through the bus. The processor 103 may access a storage unit and perform booting using an operating system (OS) stored in the memory 101 and may be configured to perform various operations described in the present disclosure while operating as an application unit using the application 102 stored in the memory 101. The processor 103 may be configured to perform various embodiments disclosed in the present disclosure by controlling components in the device of a node, that is, the memory 101, the input unit 106, the output unit 105, the transceiver unit 104, and a camera (not shown).

In addition, the system 100 for generating metadata may include various components such as the memory 101 for storing various data including data related to the application 102, the input unit 106 for receiving a user input, the output unit 105 for displaying various information, the transceiver unit 104 for communication with other terminals, and the like.

The memory 101 may be configured as a database (DB) or configured as various means of storage such as a physical hard disk, a solid state drive (SSD), a web hard, and the like.

The input unit 106 and the output unit 105 may be configured together as an input/output unit in the form of a touch display in a smartphone. The input unit 106 may be configured as a physical keyboard device, a touch display, an image input sensor constituting the camera, a sensor for receiving a fingerprint, a sensor for recognizing an iris, or the like. The output unit 105 may be configured as a monitor, a touch display, or the like. However, the input unit 106 and the output unit 105 are not limited thereto, and the system 100 for generating metadata may include a keyboard, a mouse, and a touchscreen which are used as input units in a personal computer (PC) or the like and a monitor, a speaker, and the like which are used as output units. The transceiver unit 104 may be configured as a transmitter, a receiver, or a transceiver.

The system 100 for generating metadata may be any type of handheld wireless communication device that may be connected to an external server through a wireless network such as a smartphone, a cellular phone, a personal digital assistant (PDA), a portable multimedia player (PMP), a tablet PC, or the like. In addition, the system 100 for generating metadata may be a communication device that may be connected to an external server through a network such as a desktop PC, a tablet PC, a laptop PC, and an Internet protocol television (IPTV) including a set-top box.

The application 102 extracts movement occurrence portions from a video in units of scenes in which a scene changes, extracts pose information from separated video data, and generates metadata from the pose information. A metadata generation method performed by the application 102 is the same as described above with reference to FIGS. 1 to 4, and the description thereof will not be repeated.

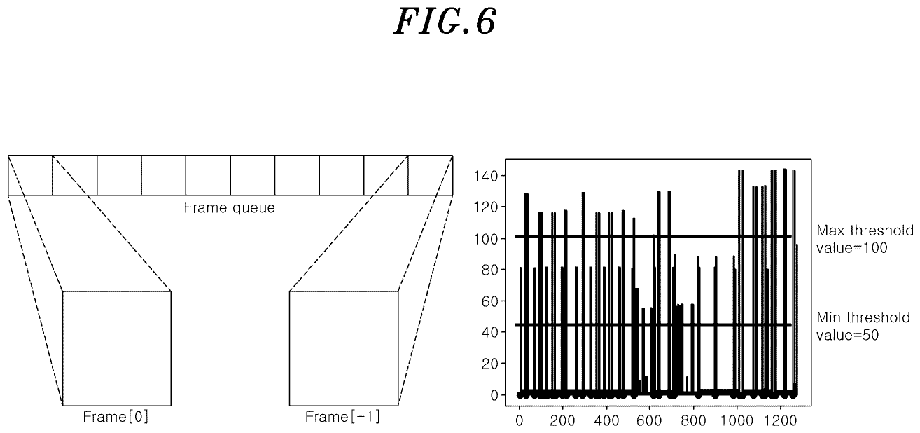

FIG. 6 is a diagram illustrating a method of extracting movement occurrence frames on the basis of a change in video intensity. Referring to FIG. 6, an example is shown in which a minimum threshold and a maximum threshold of intensity variation values acquired to classify movement candidate scenes are determined to extract time information of the intensity variation values therebetween.

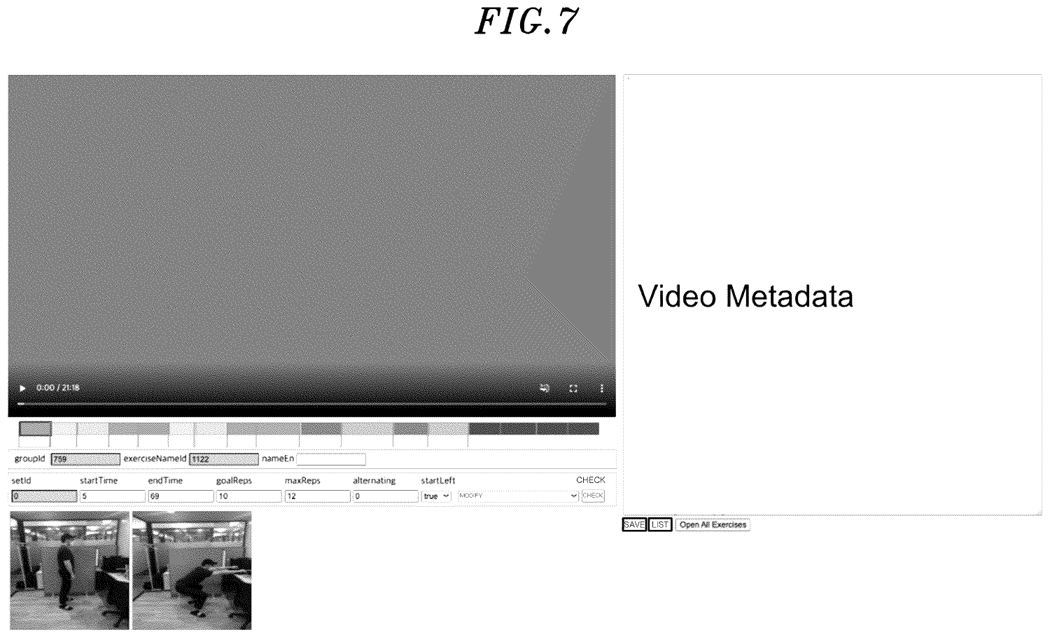

FIG. 7 depicts a process for acquiring scenes with movement in a video. Referring to FIG. 7, an example is shown in which, after an acquired video is automatically divided into scenes, a key pose is derived from poses which are essential for performing a movement, and metadata of the movement in the video is acquired.

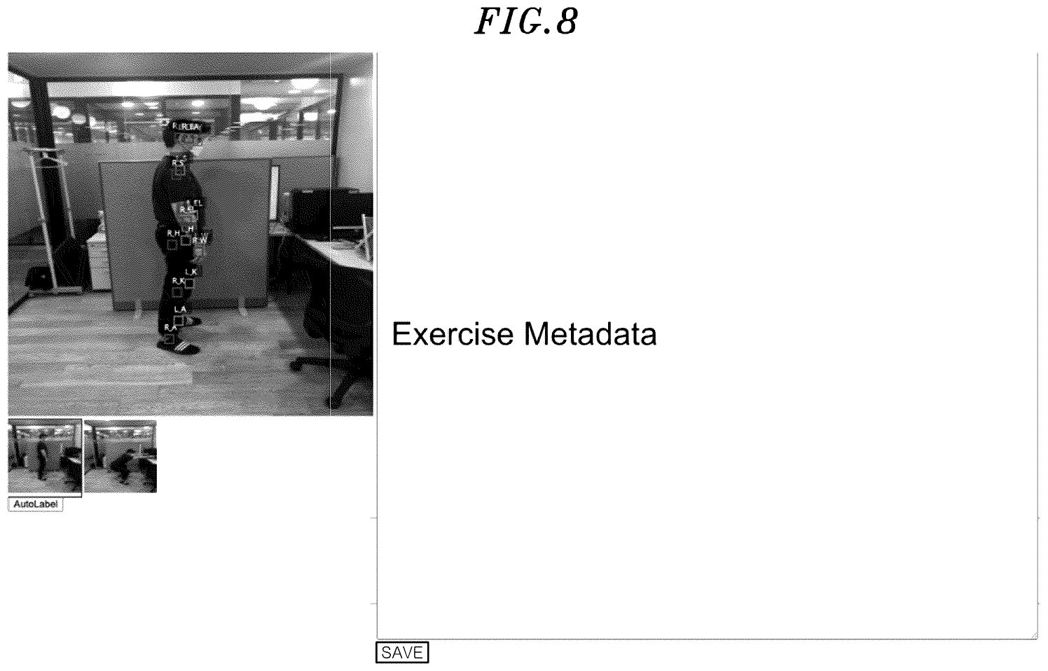

FIG. 8 depicts an example of deriving key points from a scene with movement and comparing the key points with a reference pose. Referring to FIG. 8, an example is shown in which a key pose is derived and a similarity is determined on the basis of an example of deriving key points.

Operations of a method or algorithm described in relation to embodiments of the present disclosure may be directly implemented as hardware, implemented as software modules executed by hardware, or implemented as a combination of hardware and software modules. The software modules may be present in a RAM, a ROM, an erasable programmable ROM (EPROM), an electrically erasable programmable ROM (EEPROM), a flash memory, a hard disk, a detachable disk, a compact disc (CD)-ROM, or any form of computer-readable recording medium well known in the technical field to which the present disclosure pertains.

Exemplary embodiments have been described above in the drawings and specification. Although particular terms have been used for describing the embodiments in this specification, the terms have been used only for the purpose of describing the technical spirit of the present disclosure and not for limiting meanings or the range of the present disclosure stated in the claims. Therefore, those of ordinary skill in the art should understand that various modifications and equivalent other embodiments are possible from the embodiments. Consequently, the true technical scope of the present disclosure should be determined by the technical spirit of the appended claims.

1. A method of generating metadata for movement recognition which is executable by a computing device, the method comprising:
separating movement occurrence portions from a video in units of scenes in which a scene changes;
extracting pose information from separated video data; and
generating metadata from the pose information,
wherein the extracting of the pose information comprises:
extracting key points using a deep-learning-based pose estimation model; and
determining whether a key pose of a movement is determinable and, when the key pose of the movement is indeterminable, determining the key pose from the extracted key points and generating a reference movement,
wherein the generating of the reference movement comprises:
when the extracted key points exceed a preset similarity and thus are determined as a key pose not defined in advance, determining the movement as a similar movement; and
reading movement metadata of the similar movement, and
wherein the key points of the key pose use a value approximating a size of a human and torso information as center coordinate information for comparing the key pose at a same position for a same movement.

2. The method of claim 1, wherein the extracting the pose information comprises:
extracting a movement occurrence frame on the basis of a change in video intensity;
determining whether the key pose of the movement is determinable and, when the key pose of the movement is determinable, acquiring key pose information of the movement; and
determining a similarity by comparing the extracted key points with the reference movement.

3. The method of claim 2, wherein the extracting of the movement occurrence frame on the basis of the change in video intensity comprises:
determining an intensity variation measurement region in a specific frame of the video;
acquiring intensity variation values of the intensity variation measurement region in frame units; and
extracting time information of the acquired intensity variation values between a minimum threshold and a maximum threshold from the intensity variation values acquired to derive a movement candidate scene.

4. The method of claim 3, further comprising, after the extracting of the time information of the intensity variation values, storing metadata of the movement candidate scene from a start point to an end point of a movement scene on the basis of the extracted time information.

5. The method of claim 1, wherein the generating the metadata from the pose information further comprises:
acquiring metadata of the video;
acquiring metadata of the movement; and
storing pose metadata and the movement metadata in a metadata storage unit.

6. The method of claim 1, wherein the extracting the movement occurrence portions from the video further comprises extracting the movement occurrence portions from the video in units of the scenes in which the scene changes using a computer vision-based deep learning algorithm.

7. The method of claim 1, wherein the preset similarity is determined on the basis of distance data and angle data between the extracted key points.

8. The method of claim 1, further comprising, after the reading of the movement metadata of the similar movement, finetuning metadata of the reference movement.

9. The method of claim 8, wherein the finetuning of the metadata of the reference movement comprises, when a user in whom the movement occurs is determined to be a user of movement metadata of the similar movement or metadata of the user in whom the movement occurs is similar to metadata of a user of the similar movement, finetuning the metadata of the reference movement on the basis of the metadata of the user of the similar movement.

10. A system for generating metadata comprising:
a transceiver unit configured to externally transmit and receive data through a network;
a memory unit including a video storage unit configured to store video content, a metadata storage unit configured to store pose metadata and movement metadata, and an application; and
a processor configured to read the application from the memory unit and control the system,
wherein the application, when executed by a processor, facilitated performance of operations comprising separating movement occurrence portions from a video in units of scenes in which a scene changes, extracting pose information from separated video data, and generating metadata from the pose information,
wherein:
in extracting the pose information, the application extracts key points using a deep-learning-based pose estimation model, determines whether a key pose of a movement is determinable, and when the key pose of the movement is indeterminable, determines the key pose from the extracted key points to generate a reference movement,
in the generation of the reference movement, when the extracted key points exceed a preset similarity and thus are determined as a key pose not defined in advance, the application determines the movement as a similar movement and reads movement metadata of the similar movement, and
the key points of the key pose use a value approximating to a size of a person and torso information as center coordinate information for comparing the key pose at a same position for a same movement.
